(19) United States
(12) Patent Application Publication
(10) Pub. No.: US 2018/0247561 A1
(43) Pub. Date: Aug. 30, 2018

(54) FOOTBALL TRAINING, ANIMATION TECHNIQUES, AND STATISTICAL ANALYSIS

(71) Applicant: Gridiron Innovations LLC, Pendleton, IN (US)

(72) Inventor: Toby L. Buck, Pedleton, IN (US)

(73) Assignee: Gridiron Innovations LLC, Pendleton, IN (US)

(21) Appl. No.: 15/964,356

(22) Filed: Apr. 27, 2018

Related U.S. Application Data
(62) Division of application No. 15/370,825, filed on Dec. 6, 2016, now abandoned.
(60) Provisional application No. 62/269,585, filed on Dec. 18, 2015.

(51) Int. Cl. G09B 19/00

(52) U.S. Cl. CPC G09B 19/0038

(57) ABSTRACT

A training system may provide audible and visual instruction to American football players for executing one or more coordinated movements along the line of scrimmage. The movements comprise positioning an offensive line in a first legal configuration prior to a snap, wherein a first player is lined up to snap the ball, then shifting to position the offensive line in a second legal configuration, wherein a different player is lined up to snap the ball. In some implementations, a further shift to a third legal configuration is executed before the ball is snapped, where the third configuration might or might not have the first player lined up to snap the ball. In others, only part of the offensive line shifts. The features of this system and method may be embodied in execution of the movements, training materials, training devices, computer simulations, computer gaming simulations, and statistical analysis.

### REFERENCE TO RELATED APPLICATION

This application is a divisional of U.S. Non-Provisional application Ser. No. 15/370,825, filed Dec. 6, 2016, with title “Football Games, Animation Techniques, and Statistical Analysis,” which is a nonprovisional of U.S. Provisional Application No. 62/269,585, filed Dec. 18, 2015, with title “Football Games, Animation Techniques, and Statistical Analysis”; the present application claims priority to both of the above applications.

### FIELD

This disclosure relates to training for and execution of the game of American football, simulations thereof, games relating thereto, and management of data characterizing such play.

### BACKGROUND

Football is a game of leverage, angles and numbers. For nearly a century, football coaches have X and O'd the offensive game inside and out, coming up with numerous formations, schemes, motions, and resets to add to countless plays diagramed to attack, confuse, redirect, misdirect, isolate, and rotate defenses and individual positions into submission. Creating checkdowns confuses defensive pressure calls and manipulates the defense to play conservatively.

Recently we have seen teams using a no-huddle strategy with quick tempo, and then spreading the field horizontally. The quick tempo keeps the defense from calling sophisticated plays or substituting players based on personnel, down, and distance situations, and it may even manipulate the defense into calling their plays based on the offense's formation and tendency. By spreading the field, the defense is often forced to tip its hand in blitz situations because of the distance Linebackers and Safeties have to creep in order to achieve proper timing for their blitz to be effective. Keeping this in mind, the no-huddle strategy allows for simple isolation reads by the Quarterback on single defensive players for both run and pass plays. That is why run pass options (“RPO”) such as zone-read run plays and isolation pass play offense appear to be trending.

Of course, what is the natural progression for defenses to resort to when having to defend against this style of offense? Playing quicker players at the Outside Linebacker positions instead of bigger players who react more slowly and cannot keep up with the fast-paced tempo offenses.

Most offensive coordinators are having to make a choice: (1) Go with bigger, stronger players, and focus on running the ball and controlling the clock by eating time up; (2) choose to play with smaller and faster players, spread the field and out-score your opponent regardless of the game clock; or (3) straddle the fence and try to play a combination of both.

### SUMMARY

The present disclosure describes a training technique for American football comprising a method that will fit into any type of offensive strategy. It creates confusion, out-leverages the defense, creates superior blocking angles, creates a statistical nightmare for defensive coaches, and allows for simple reads for the quarterback. The key here is leverage. No longer is a coach cornered with a decision to recruit or sign bigger, stronger players versus smaller, quicker players for the same positions. Leverage is the universal equalizer regardless of size, strength or speed. The present shift method will manipulate the defense to check out of pressures, check into base coverages, and play predictable adjustments. The disclosure describes a form of football that includes an offensive “scheme,” or method, not an abstract offense. It can be incorporated into play calling using simple language, and it can be “plugged” into any offensive style.

This disclosure also describes graphical/computer simulations of such a game for training and entertainment, coaching, teaching, statistical analysis of this form of football, and related processes.

### BRIEF DESCRIPTION OF THE DRAWINGS

FIG. 1 is a schematic diagram showing positions of traditional offensive and defensive lines in American football.

FIG. 2 is a schematic diagram showing an exemplary identification of middle offensive linemen for use in one embodiment of the disclosed method.

FIG. 3 is a schematic diagram showing an exemplary shift and subsequent play according to one embodiment of the disclosed method.

FIG. 4 is a schematic diagram showing an exemplary shift and subsequent play according to a second embodiment of the disclosed method.

FIG. 5 is a schematic diagram showing an exemplary shift and subsequent play according to a third embodiment of the disclosed method.

FIG. 6 is a schematic diagram showing an exemplary shift and subsequent play according to a fourth embodiment of the disclosed method.

FIG. 7 is a schematic diagram showing an exemplary shift and subsequent play according to a fifth embodiment of the disclosed method.

FIG. 8 is a schematic diagram showing an exemplary shift and subsequent play according to a sixth embodiment of the disclosed method.

FIG. 9 is a schematic diagram showing an exemplary shift and subsequent play according to a seventh embodiment of the disclosed method.

FIG. 10 is a schematic diagram showing an exemplary shift and subsequent play according to an eighth embodiment of the disclosed method.

FIG. 11 is a schematic diagram showing an exemplary shift and subsequent play according to a ninth embodiment of the disclosed method.

FIG. 12 is a schematic diagram showing an exemplary shift and subsequent play according to a tenth embodiment of the disclosed method.

FIG. 13 is a schematic diagram showing an exemplary shift and subsequent play according to a eleventh embodiment of the disclosed method.

FIG. 14 is a schematic diagram showing an exemplary shift and subsequent play according to a twelfth embodiment of the disclosed method.

FIG. 15 is a schematic diagram showing an exemplary shift and subsequent play according to a thirteenth embodiment of the disclosed method.

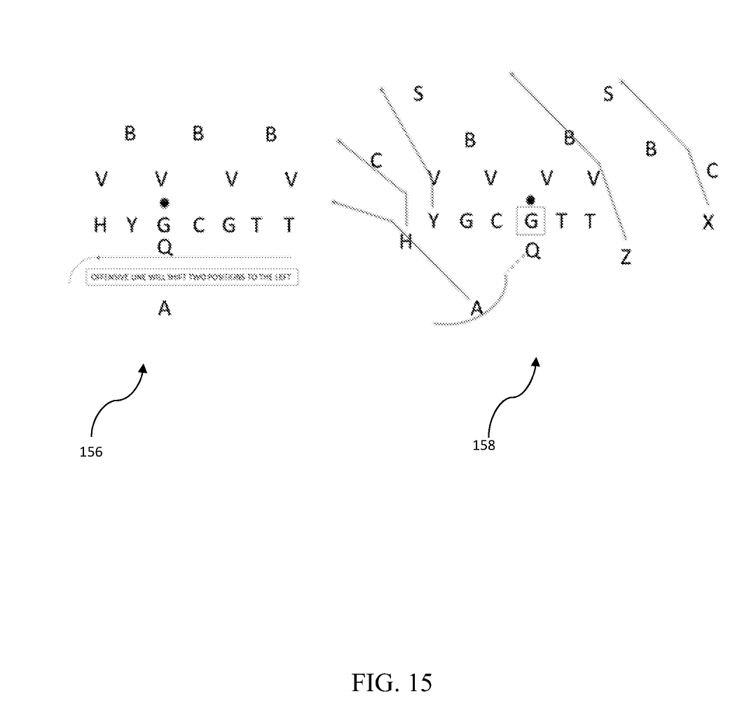

FIG. 16 is a schematic diagram showing an exemplary shift and subsequent play according to a fourteenth embodiment of the disclosed method.

FIG. 17 is a schematic diagram showing an exemplary shift and subsequent play according to a fifteenth embodiment of the disclosed method.

FIG. 18 is a schematic diagram illustrating offensive line gaps for use in various embodiments of the disclosed method.

FIG. 19 is a schematic diagram showing an exemplary shift and subsequent play according to a sixteenth embodiment of the disclosed method.

FIG. 20 is a schematic diagram showing an exemplary shift and subsequent play according to a seventeenth embodiment of the disclosed method.

FIG. 21 is a schematic diagram showing an exemplary shift and subsequent play according to an eighteenth embodiment of the disclosed method.

FIG. 22 is a schematic diagram showing an exemplary shift and subsequent play according to a nineteenth embodiment of the disclosed method.

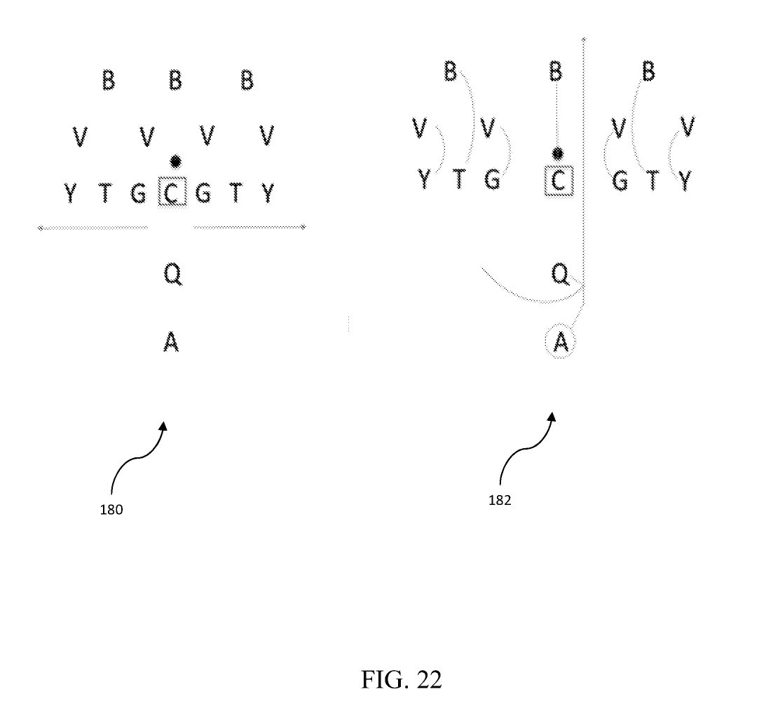

### DESCRIPTION

For the purpose of promoting an understanding of the principles of the present invention, reference will now be made to certain embodiments, some of which are illustrated in the drawings, and specific language will be used to describe the same. It will, nevertheless, be understood that no limitation of the scope of the invention is thereby intended; any alterations and further modifications of the described or illustrated embodiments, and any further applications of the principles of the invention as illustrated therein, are contemplated as would normally occur to one skilled in the art.

Football, like other sports, is constrained by a set of rules. The Buck Shift method is unique and simple, beginning with the definition of one of the most basic and fundamental rules at all levels of the game: the requirements placed on the offensive line at the snap. From the NFL Rule Book, which is also used at the college level by schools in the NCAA:

### Section 5 Position of Players at the Snap

Article 1: Offensive Team. The offensive team must be in compliance with the following at the snap:
(a) It must have seven or more players on its line (3-19-1); and
(b) Eligible receivers must be on both ends of the line, and all of the players on the line between them must be ineligible receivers.
(c) No player may be out of bounds.

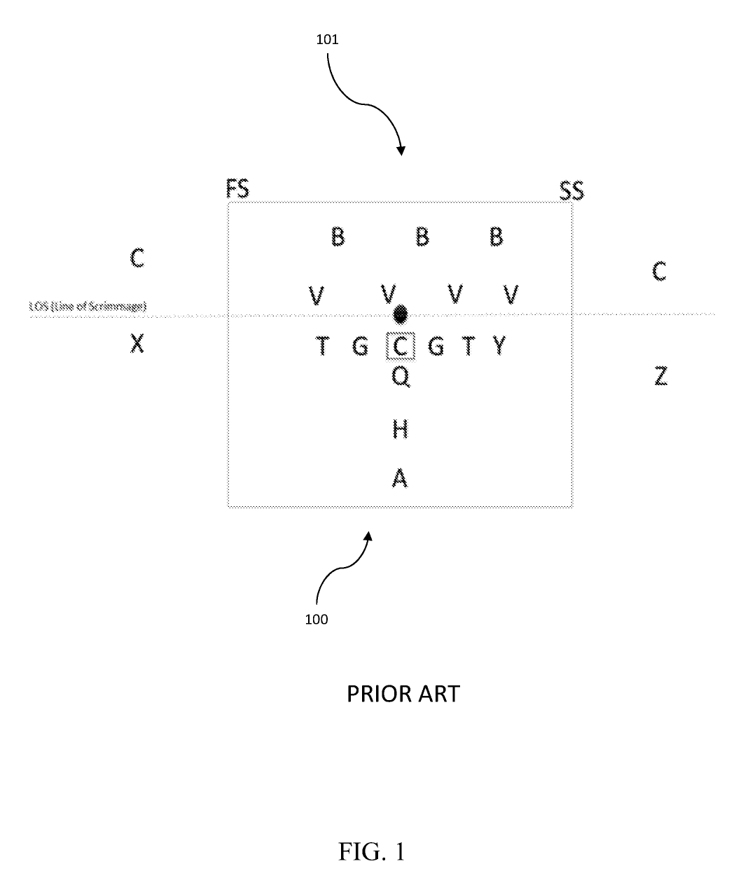

FIG. 1 shows an illustration of a typical offensive alignment (100) and an opposing defensive alignment (101). Each position is represented by a letter, for example, C for center, G for guard, T for tackle, Y for tight end, QB for quarterback, H for fullback, A for tailback, X and Z for wide receivers, V for defensive lineman, B for linebacker, C for corner, FS for free safety, and SS for strong safety.

The basic premise of the present implementation of the Buck Shift method comprises the five ineligible players on the line of scrimmage (“LOS”): a Tackle, Guard, Center, Guard, and Tackle (“T, G, C, G, T”), but may also include one or two Tight Ends (“Y”) and a Fullback (“H”) or Receiver (“X”) at various stages of its development as illustrated herein.

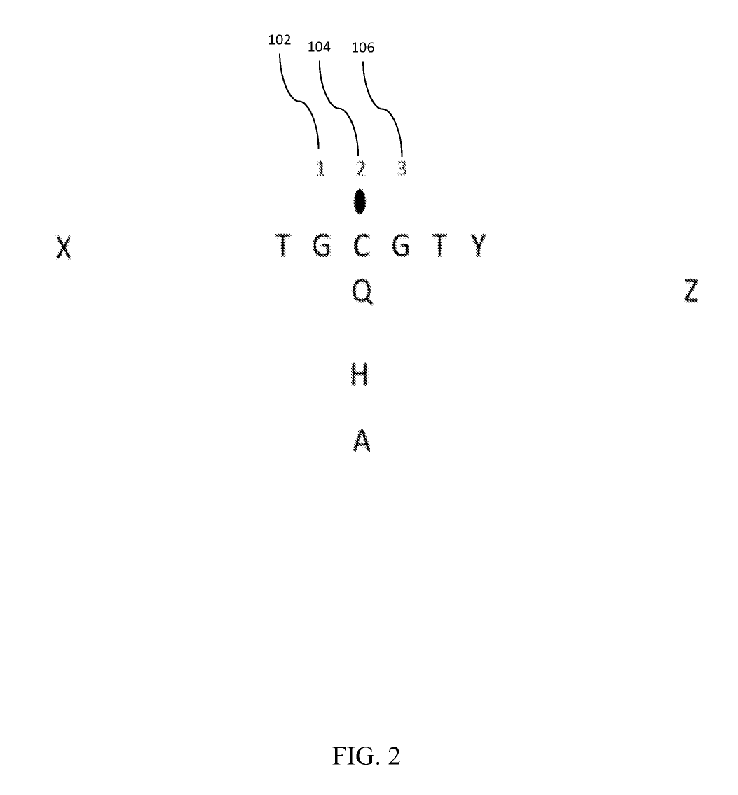

FIG. 2 illustrates the Buck Shift numbering assignment for the three middle offensive linemen, with the left guard (102), center (104), and right guard (106).

The five ineligible offensive linemen, by rule, all have jersey numbers ranging from #50-79. This is how they are identified as ineligible to catch a forward pass (unless a particular exception applies).

In contrast with Offensive Tackles, who are typically tall, wide and long armed, Centers and Guards are usually of the same proportionate build: shorter than Tackles, stocky and more mobile. Guards are also coached up on how to snap the ball as Centers so they can replace the Center if that player were ever injured. This “cross-training” helps a team to effectively execute the Buck Shift.

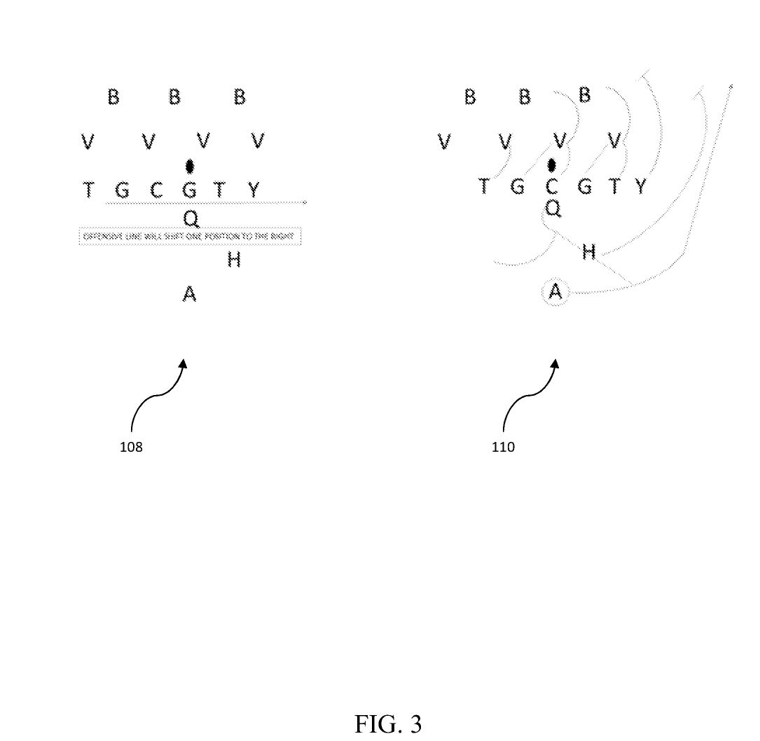

FIG. 3 shows one potential implementation of the illustrated method that may be referred to as Center Over Right. In the initial lineup or pre-Buck shift position (108) shown on the left side of FIG. 3, the Center is not aligned over the football. Once the Quarterback sees the defensive alignment and is ready, he gives the command to shift, and the entire offensive line moves together to a post-shift position (110) in unison the direction of the call. In this case, the entire offensive line will shift one position to the right and then the Center will be over the ball, thus, “Center Over.” As one can see, by running a standard Toss Sweep Right, the offense has now gained and can capitalize on a competitive advantage by numbers and leverage on the right side.

The language of the call “Left Buck 232” will now be explained in the context of this exemplary implementation. In the huddle, the call is Left Buck 232. The Y lines up on the left or right depending on the first command, which may be, for example right or left. Any particular implementation of this system may have its own codes or commands, such as right-left or any other arbitrary command or phrase. The first number, 2, refers to the direction of the Buck Shift. (1 is left, 2 is right.) The second number refers to the lineman lining up over the ball. Remember (as shown in FIG. 2), the Left Guard is #1, the Center is #2, and the Right Guard is #3. In this case, 3 (the Right Guard) is lining up over the ball. The third number refers to the lineman who will be snapping the ball after the Buck Shift. In this case, the lineman snapping the ball is #2, the Center, so the call is Left Buck 232.

As one can clearly see, the offense has gained and can capitalize on an advantage through leverage as they execute a simple Toss Sweep right. The blocking angles are sharper, which negates size, speed, and strength as competitive factors. All other things being equal, the Buck Shift gives the offense a significant blocking advantage.

Because the Buck Shift is a “pre-snap” shift, or movement, a review of the rules of “shifts” and “false starts” might be useful to illustrate that the Buck Shift complies with all of these rules.

Some rules relevant to the Buck Shift include:

### Section 31 Shift

### SHIFT

A Shift is the action of two or more offensive players who (prior to a snap), after having assumed a set position, simultaneously change the position of their feet by pivoting to or assuming a new set position with either one foot or both feet (7-4-8).
Article 8: Shifts. The offensive team is permitted to shift and have two or more players in motion multiple times before the snap. However, after the last shift, all players must come to a complete stop and be in a set position simultaneously for at least one second. If any eligible backfield player goes in motion (one at a time) after the last shift and comes to a complete stop, there is no requirement for a full second pause before a second player can legally go in motion.
However, if the first player has not come to a complete stop when the second player goes in motion, it is another shift and requires another simultaneous stop for at least one second by all players.
It is also an illegal shift if a player under or behind center goes in motion and fails to come to a complete stop for at least one full second prior to the snap, or before a second player goes in motion.
Note: The offensive team must present a legal formation both before and after a shift.
Penalty: For an illegal shift: Loss of five yards.
A.R. 7.31 Team A shifts and comes to a stop for one second. Offensive End A1 then goes out along his line and stops. Back A2 then moves and the ball is snapped less than one second after End A1 stops.
Ruling: Legal play. Movement of End A1 and Back A2 are not simultaneous.
A.R. 7.32 After a shift or a huddle, the offensive players come to a stop and remain stationary. Before the lapse of one second, Back A1, who did not shift or huddle, starts and is in motion backward at snap.
Ruling: Illegal shift. All eleven players must come to an absolute stop for one second.
Article 2: False Start. It is a False Start if the ball has been placed ready for play, and, prior to the snap, an offensive player who has assumed a set position charges or moves in such a way as to simulate the start of a play, or if an offensive player who is in motion makes a sudden movement toward the line of scrimmage. Any quick abrupt movement by a single offensive player, or by several offensive players in unison, which simulates the start of the snap, is a false start.

### Exceptions:

(a) This does not apply to an offensive player under the center who turns his head or shoulders, unless the movement is an obvious attempt to draw an opponent offside.
Note: See 4-6-5-d, for actions by a defensive player who attempts to cause an offensive player to commit a false start.
Item 1: Interior Lineman. It is a False Start if an interior lineman (tackle to tackle) takes or simulates a three-point stance, and then changes his position or moves the hand that is on the ground.
Item 2: Change of Stance. An interior lineman who is in a two-point stance is permitted to reset in a three-point stance or change his position, provided that he resets prior to the snap.
Item 3: Eligible Receiver. If an eligible receiver who is on the line changes his stance, or moves to another position on the line or in the backfield, he must reset prior to the snap. If an eligible receiver who is in the backfield changes his stance, or moves to another position in the backfield that is closer to the line of scrimmage or to a position on the line, he must reset prior to the snap. (For a backfield player who is moving parallel to or away from the line of scrimmage, see Article 7.)
Item 4: Player Under Center. It is legal for a player who has taken a position under or behind the center to go in motion, whether he has placed his hands under center, on his knees, or on the body of the center. However, it is a False Start if the action is quick and abrupt. If the player fails to come to a complete stop for at least one second prior to the ball being snapped, it is an illegal shift. See 7-4-8.
Item 5: Shotgun Formation. A player who is in position to receive the snap in shotgun formation is permitted to shift his feet prior to the snap, but any quick and abrupt movement is a False Start. This includes thrusting his hands forward when there is not a simultaneous snap.
Item 6: Attempt to Draw Offside. Any obvious attempt by the quarterback or other player in position to receive the snap to draw an opponent offside is a False Start.

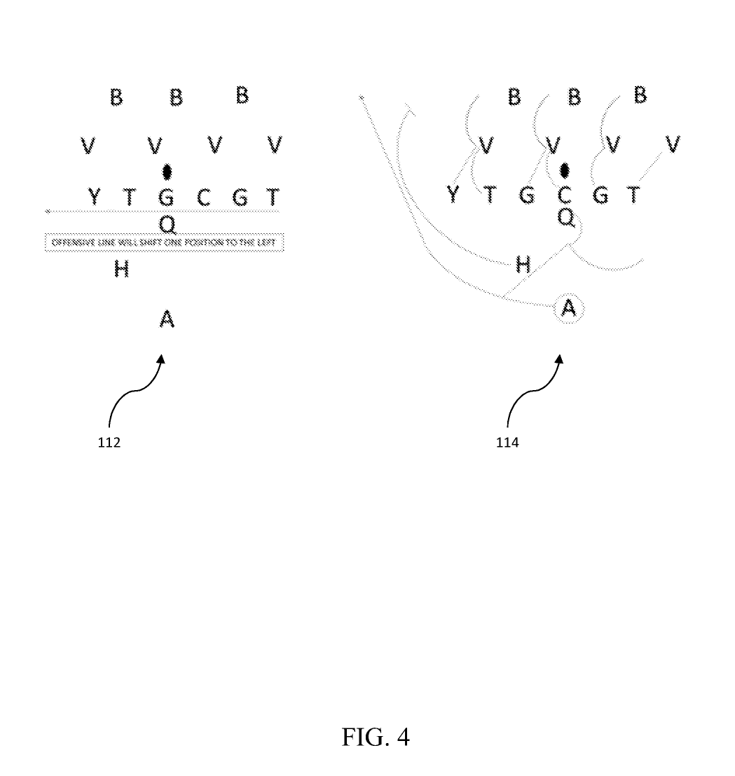

In the lineup shown in FIG. 4, which may be referred to as Center Over Left, the Center is not aligned over the football in the initial position (112). Once the Quarterback sees the defensive alignment and is ready, he gives the command to Buck Shift, and the whole offensive line moves together in unison the direction of the call to the second position (114). In this case, the entire offensive line will Buck Shift one position to the left, and the Center will be over the ball, thus, this alignment might be referred to as a “Center Over.” As you can see, the offense has now gained a competitive advantage by numbers and leverage on the left side.

According to the present implementation, this is scheme “Left Buck 112, 21P.” To explain this notation, the Y goes in the direction of the first command, which is left. The first number, 1, refers to the direction of the left. The second number, 1, identifies the lineman lining up over the ball. In this case it is #1 (the Left Guard). The third number refers to the lineman who will be snapping the ball after the Buck Shift. In this case the player is #2, the Center, completing the information conveyed by “Left Buck 112.”

One strategic consideration for the Buck Shift method is that it and its variations be introduced in strategic sequence. Keeping that in mind, another potentially powerful element is for it to be executed with “tempo,” wasting no time from down to down, by lining up on the ball in unison as quickly as possible, then executing the called play right away. By using tempo, defensive substitutions are limited. Defensive play calls are limited because of the lack of time to adjust to the offense's formations, and in general, the defense gets tired and is forced to play a conservative “base” scheme. Since the offense can execute a Buck Shift, go to “set” for just one second, then snap the ball, the defense is forced to react to the Buck Shift instead of responding strategically. Now, the offense will not perform a Buck Shift on every play, so the defense will have to be sharp enough to recognize the shift quickly. As the defense gets tired and the Buck Shift is run in tempo, the defense will not be able to respond as a unit in reacting to the Buck Shift.

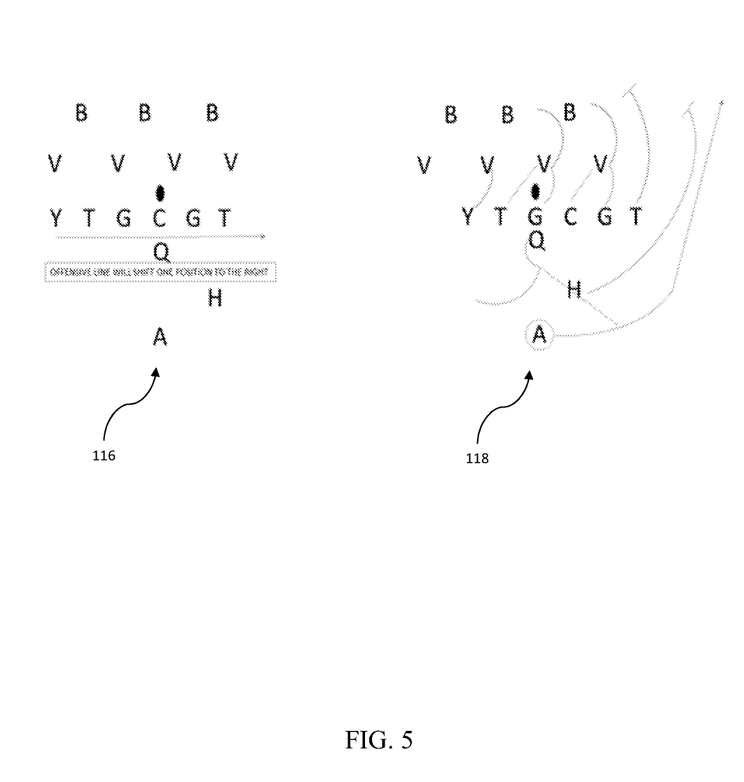

In FIG. 5 a formation is shown which may be referred to as Guard Over Right. Here one will notice that the Center lines up over the football in the first position (116). Once the Quarterback sees the defensive alignment and is ready, he gives the command to shift, and the whole offensive line moves together in unison in the direction of the Buck Shift according to the call to the second position (118). In this case, the entire offensive line will Buck Shift one position to the right, and the guard will be over the ball, so this lineup might be referred to as a “Guard Over.” The offense has now gained a competitive advantage by numbers and leverage on the right side.

According to the present implementation, this is play call “Right Buck 221, 21P.” The Y lines up left or right according to the first command of the Quarterback. The first number in the Quarterback's call, 2, refers to the direction of the Buck Shift. (1 is Left; 2 is Right.) The second number refers again to the lineman lining up over the ball. As above, the Left Guard is #1, the Center is #2, and the Right Guard is #3. In this case, 2 is lining up over the ball (the Center). The third number refers to the lineman who will be snapping the ball after the Buck Shift. In this case it is #1, the Left Guard.

When a defense first sees the Buck Shift as Center Over, they will eventually notice that the “usual” Center is not lining up over the ball. This will result in the defense paying closer attention to the alignment of the front five. So when the offense lines up in Guard Over, the defense will not suspect that there will be a shift.

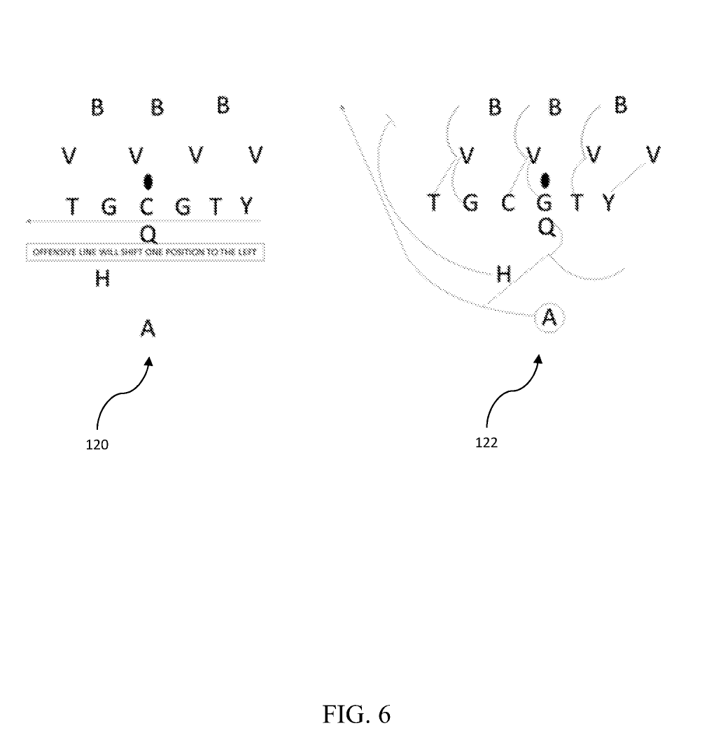

In the lineup shown in FIG. 6, which may be referred to as Guard Over Left, the Center lines up over the football in a first position (120). Once the Quarterback sees the defensive alignment and is ready, he gives the command to Shift, and the whole offensive line moves together in unison in the direction of the call to a second position (122). In this case, the entire offensive line will Buck Shift one position to the left, and the Guard will be over the ball, so this shift might be called “Guard Over.” As one can see, the offense has now gained a competitive advantage by numbers and leverage on the left side.

In the present implementation, this illustrated movement is called “Left Buck 123, 21P”. The Y lines up left or right according to the first command of the Quarterback. The first number, 1, gives the direction of the Buck Shift. The second number identifies the lineman lining up over the ball; in this case, 2 (the Center) is lining up over the ball. The third number identifies the lineman who will be snapping the ball after the Buck Shift. In this case it is #3, the Right Guard.

The illustrations in FIGS. 1-6 have used “21P” sets, for a Personnel group having 2 Back, and 1 Tight End. The next couple of sets will use a “12P” set, which has 1 Back and 2 Tight Ends. Other possible personnel groupings include:

TABLE 1
Personnel Groupings

| Group # | Backs | Tight Ends |
|---|---|---|
| 00P | 0 (5 Receivers) | 0 |
| 10P | 1 | 0 |
| 11P | 1 | 1 |
| 12P | 1 | 2 |
| 21P | 2 | 1 |
| 22P | 2 | 2 |
| 23P | 2 | 3 |
| 31P | 3 | 1 |
| 32P | 3 | 2 |

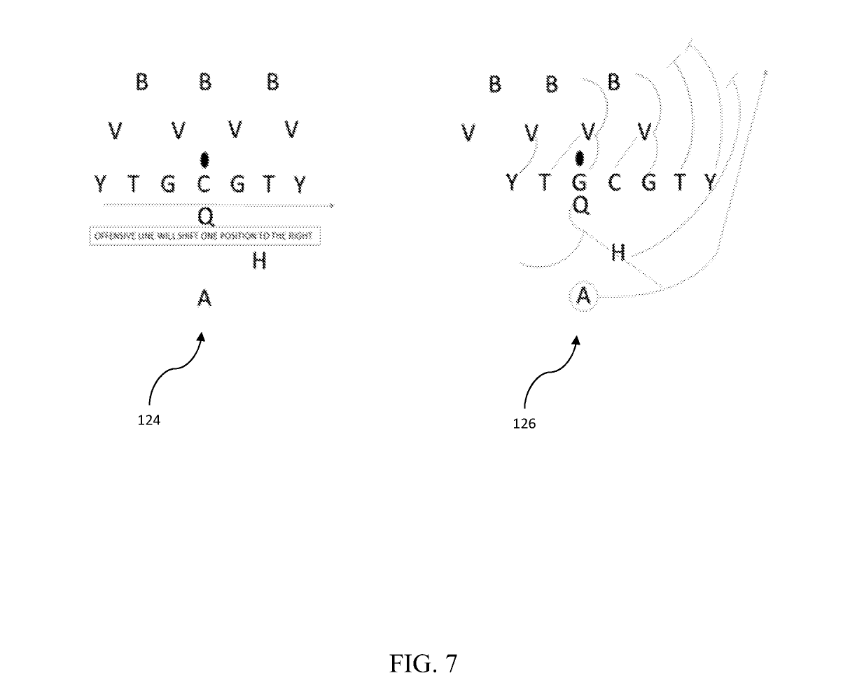

Notice in FIG. 7, in a formation which may be referred to as Monster Buck Guard Over Right, that the Center lines up over the football in a first position (124), and the offense lines up in a symmetrically balanced formation. Once the Quarterback sees the defensive alignment and is ready, he gives the command to Shift, and the whole offensive line moves together in unison the direction of the call to a second position (126). In this case, the entire offensive line will Buck Shift one position to the right, and the guard will be over the ball, so this movement might be called “Guard Over.”

One might call this set Monster Buck (or another chosen phrase, command, or descriptor) as it is a double Tight End set, in this case, 22P. As one can see in FIG. 7, when combined with the Buck Shift, the front transforms to an unbalanced right alignment. This figure illustrates Monster Buck 221, in which the call system remains the same. The first number, 2, refers to the direction of the Buck Shift (right). The second number, 2, refers to the lineman lining up over the ball (the Center). The third number, 1, refers to the lineman who will be snapping the ball after the Buck Shift (the Left Guard). Therefore, this might also be considered a “Guard Over” concept.

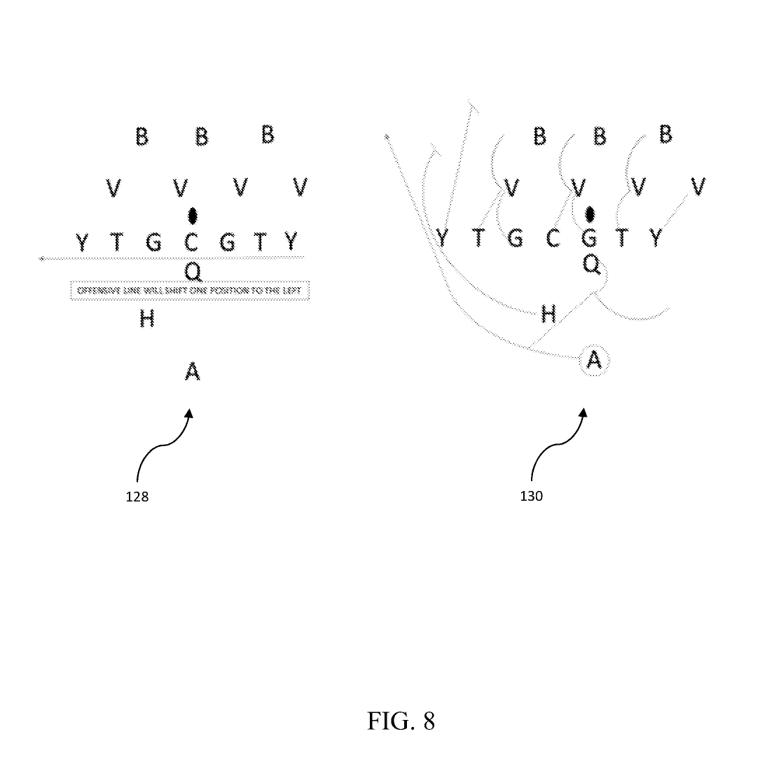

FIG. 8 illustrates a sixth example, “Monster Buck 123, 22P,” or Monster Buck, Guard Over Left. The “Monster” call means that one Y lines up on each end of the offensive line. The first number, 1, refers to the direction of the Buck Shift (left). The second number, 2, identifies the lineman lining up over the ball (the Center). The third number, 3, refers to the lineman who will be snapping the ball after the Buck Shift (the Right Guard).

Since MONSTER BUCK uses two Tight Ends, in this case a 22P composition, when combined with the Buck Shift, the front transforms from the first position (128) to an unbalanced line in the second position (130). That also makes this a “Guard Over” concept.

Now we highlight one of the Buck Shift's greatest byproducts. If the defense has now witnessed three variations with different players snapping the ball, and the entire offensive line moving one gap to the left or to the right, they have realized something very important: When the Offensive line approaches the LOS, no one grabs the ball. You see, once the ball has been grabbed, it cannot be released but through the snapping process. With the Buck Shift method, the offense has been conditioned (coached) not to grab the football until the “set” call has been made. Waiting to grab the balls freezes the defense from making any pre-snap plays, shifts, stunts, blitz, or strength calls. They do not know if the offense is going to Buck Shift or not. By not grabbing the ball, they prevent the defense from any pre-snap calls, plays, or adjustments. This means that even on plays where the offense does not perform a Buck Shift the defense will not even know that until the offense grabs the ball and calls “set.”

Of course, the defense can make their call, but they will only have one second to make it, adjust, and begin to execute it correctly.

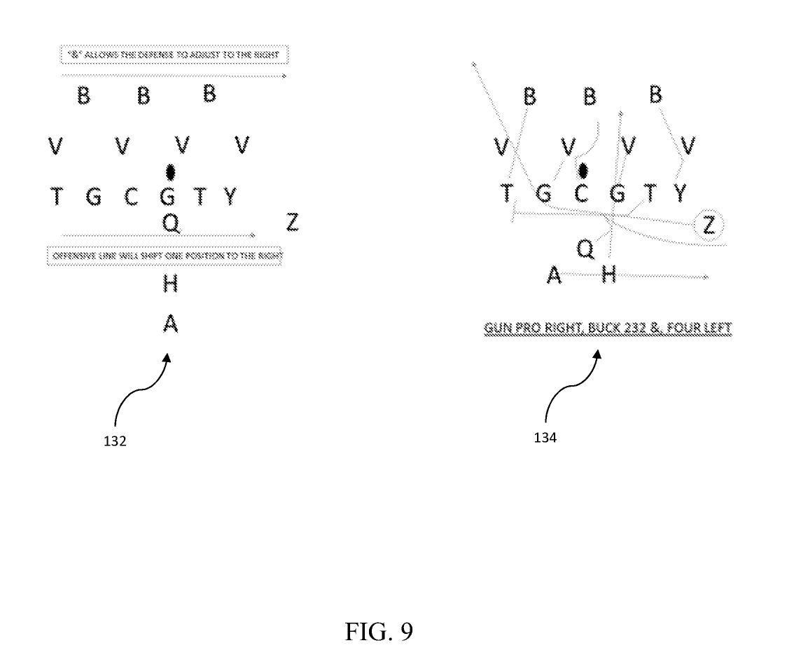

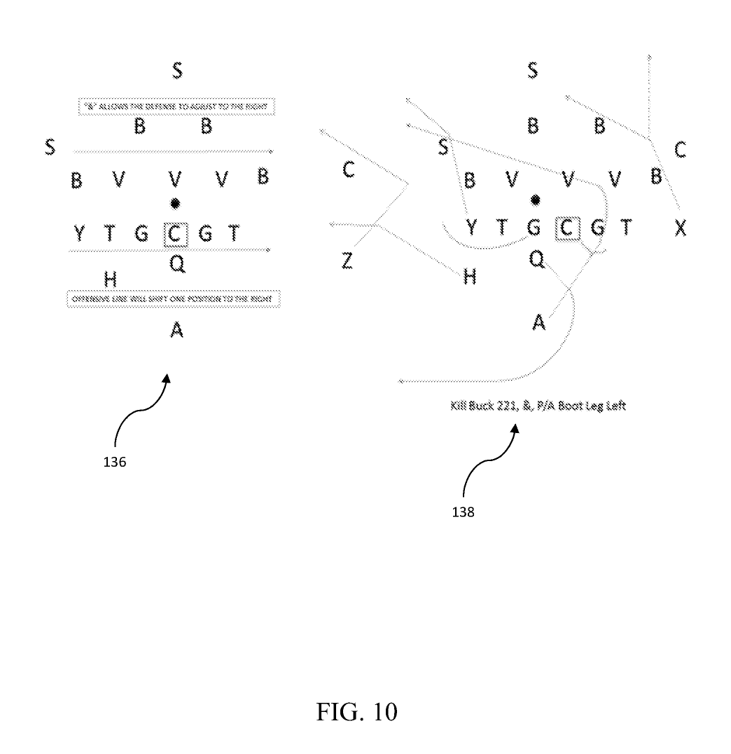

FIGS. 9 and 10 illustrate an intentional delay after a Buck Shift, which may be referred to as “and” or &, to allow the defense to adjust. (The “&” sign stands for “let the defense adjust.”) That is, once the offense performs the Buck Shift method, the Quarterback will pause longer than the one second prior to the snap, possibly 3-10 seconds depending on the play clock. In this case, the offense wants the defense to adjust, since their likely adjustment sets them up for the offensive play that was called. We observe that tempo is used in several ways, e.g., no-huddle, hurry-up, and the two-minute drill. However, by slowing down the tempo and milking the 35-second clock, the offense slows down the pace to burn time. With the Buck Shift, the offense can take advantage of both time strategies. In FIG. 9, the offense runs a “Buck 232 &” with a counter run play to the back side, away from the direction of the Buck Shift. By pausing after the Buck Shift and letting the defense adjust to what appears to be a likely run right (because of the transition from the first position (132) to the second position (134)), the offense sets itself up for a misdirection play back away from the Buck Shift. Likewise, as shown in FIG. 10, a Buck Shift from a first position (136) to the right to a second position (138) apparently sets up a strong-side run, but actually misdirects the defense to be vulnerable to a bootleg pass to the weak side.

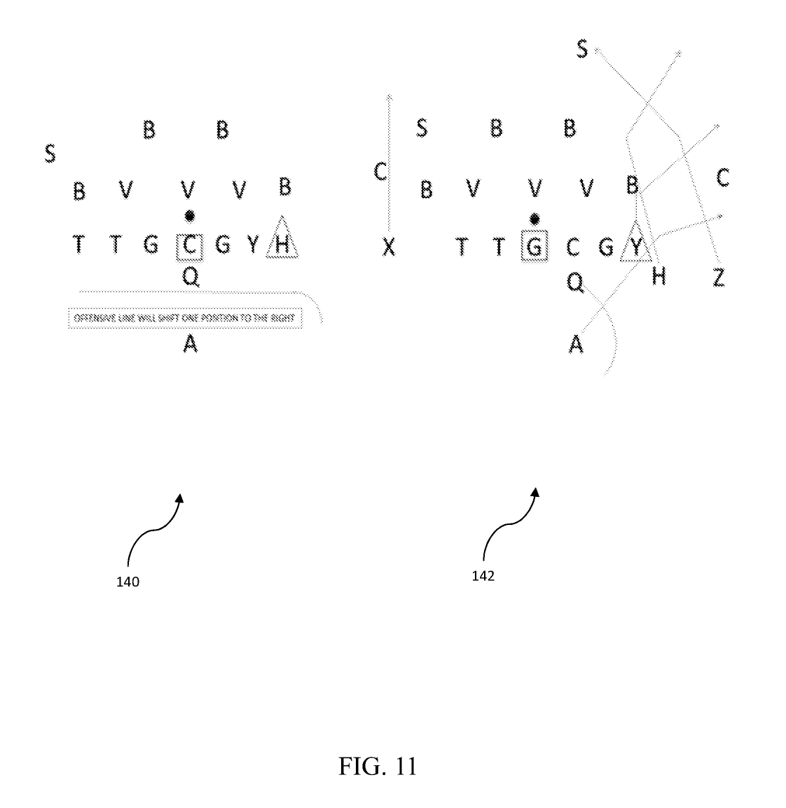

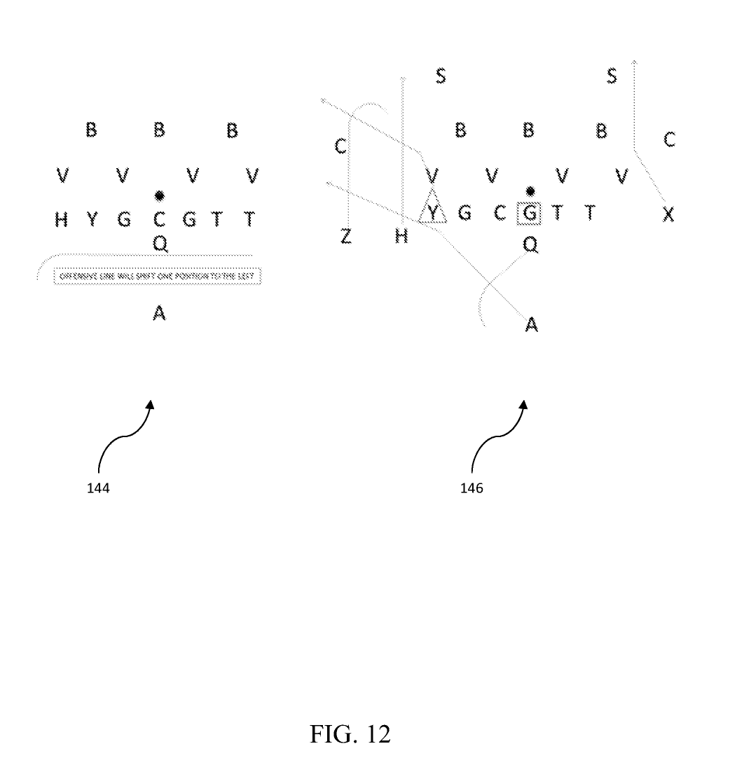

FIGS. 11 and 12 illustrate a Guard Over, Tackle-opposite, uncover-Y scheme, which may be referred to as Camo Buck Right and Camo Buck Left. The Tackle lines up away from the Y's “left” or “right” call. During the Buck Shift from a first position (140 or 144) to a second position (142 or 146), the H not only slides over but backs off the LOS as well. This exposes the Y as the end man on the LOS, so Y becomes eligible. (The triangle in these figures depicts the end man on the LOS before and after the Buck Shift.) Now the offense in this embodiment has effectively shifted to a trips formation (that is, with three eligible receives on the same side of the field) and snapped the ball in 2.5 seconds. When executed in tempo, the defense will likely not recognize the Y as eligible.

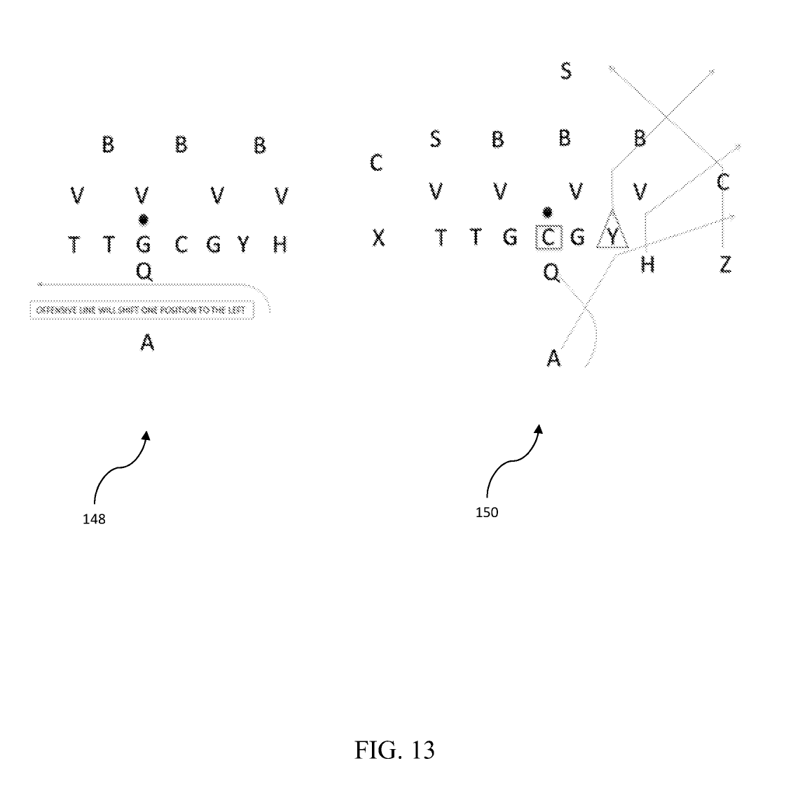

FIG. 13, in a formation which may be referred to as Camo Buck Reveal, illustrates a lineup as an unbalanced right in a “Camo Right Buck 112, Reveal, &” call. The offense will shift away from a first position (148) to a second position (150) and have the H come off the LOS as in the previous Camo scheme, thus revealing the Y as eligible. Because we are in “&” and let the defense adjust to the Buck Shift, running the play action back away from the Buck Shift provides a misdirection and exposes an eligible receiver in Y who is likely to be unaccounted for by the defense. See the NFL/NCAA Rules regarding Eligible Receivers in the following passage:

### Section 5 Position of Players at the Snap

Article 1: Offensive Team. The offensive team must be in compliance with the following at the snap:
(a) It must have seven or more players on its line (3-19-1); and
(b) Eligible receivers must be on both ends of the line, and all of the players on the line between them must be ineligible receivers.
(c) No player may be out of bounds

### Eligible Receivers

Article 5 Eligible Receivers. The following players are eligible to catch a forward pass that is thrown from behind the line of scrimmage.
(a) Defensive players.
(b) Offensive players who are on either end of the line, provided they either have the numbers of eligible players (1-49and 80-89) or have legally reported to play a position on the end of the line. See 5-1-2.
(c) Offensive players who are legally at least one yard behind the line at the snap, provided they either have the numbers of eligible players (1-49 and 80-89) or have legally reported to play a position in the backfield.
(d) All other offensive players after the ball has been touched by any defensive player or any eligible offensive player.

### Ineligible Receivers

Article 6 Ineligible Receivers. All offensive players other than those identified in Article 5 above are ineligible to catch a legal or illegal forward pass thrown from behind the line of scrimmage, including:
(a) Players who are not on either end of their line or at least one yard behind it when the ball is snapped.
(b) Offensive players wearing numbers 50-79, unless they have reported a change in their eligibility status to the Referee and have assumed a position on their line or in their backfield as required by Article 5;
(c) Players who fail to notify the Referee of being eligible when required;
(d) An eligible receiver who has been out of bounds prior to or during a pass, even if he has re-established himself inbounds with both feet or with any part of his body other than his hands.

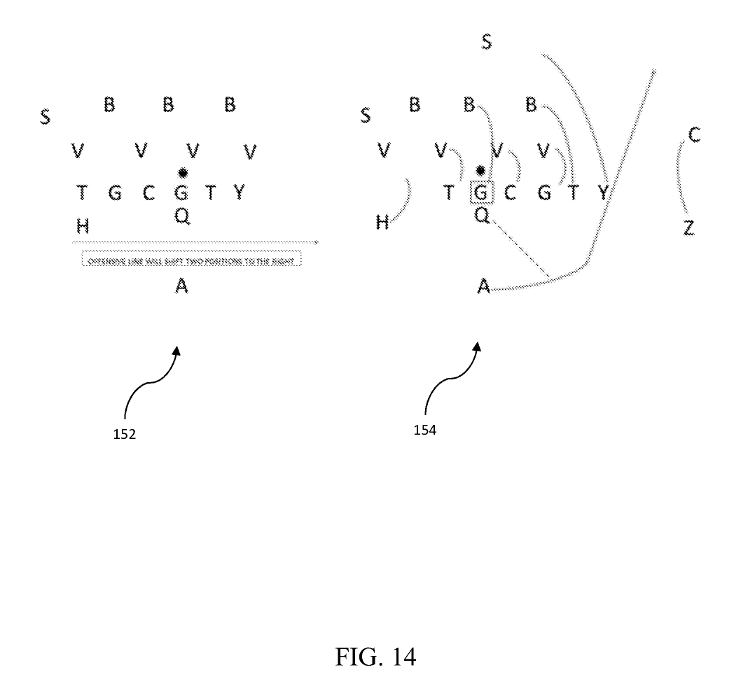

FIGS. 14 & 15 illustrate what may be referred to as a “TWO BUCK” right or left, in which the offensive line will slide two positions with tempo from a first position (152 or 156) to a second position (154 or 158), then snap. The object here is to get out ahead of the defense where they just cannot comprehend stemming two gaps, especially all together. Any stunt, blitz or combination pressure by the defense will be off by two gaps, or they will be forced to check to a base call. As shown in these figures, the offense can reset other positions as well in order to confuse and out-flank the defense before they can adjust effectively.

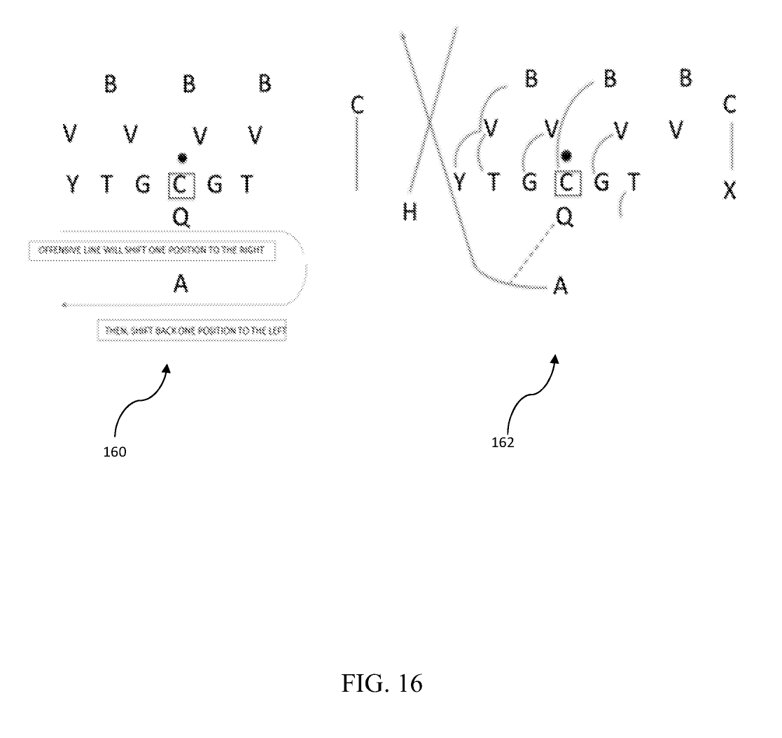

Just because the offense Buck Shift in one direction does not mean they have to stay put. FIG. 16 illustrates a “Left Buck 221 &, Foxtrot 1.” The advantage here comes once a defense thinks they have it figured out and they design a pressure for after the Buck Shift. Then the offense “Foxtrots” back one gap with tempo, then snaps the ball. While some defenders may stem back from the second position (162) to the first position (160), it is unlikely that all of them would adjust, and they are even less likely to do so while running an effective pressure. The Foxtrot is likely to manipulate them into playing a conservative defense.

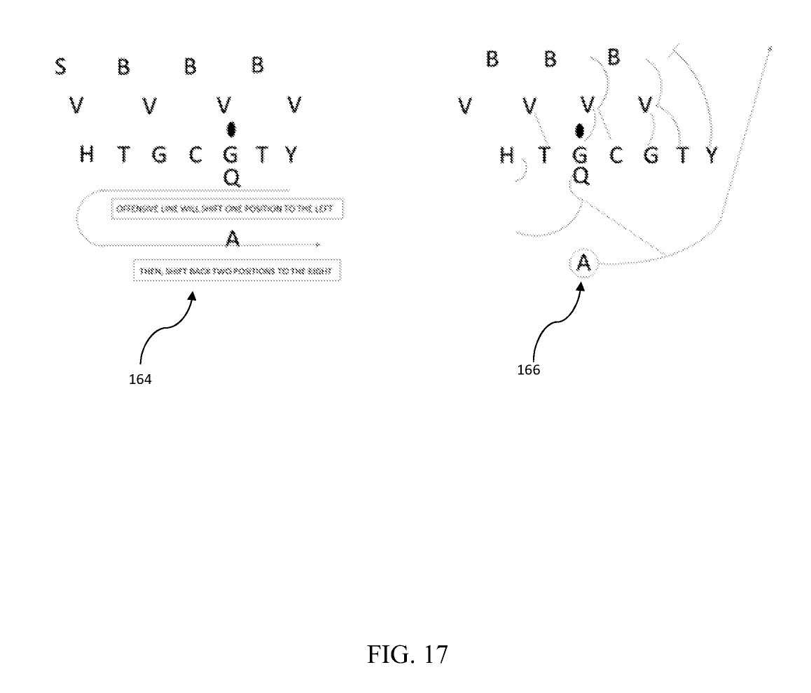

Next is “Left Buck 221 &, Foxtrot 2,” as illustrated in FIG. 17. Once again, the offense pauses after the initial shift, lets the defense adjust from the first position (164) to the second position (166), does a “Foxtrot 2” back two gaps with tempo, then snaps the ball. This scheme is much more clearly illustrated when viewed with the Buck Shift-enabled animation software discussed herein.

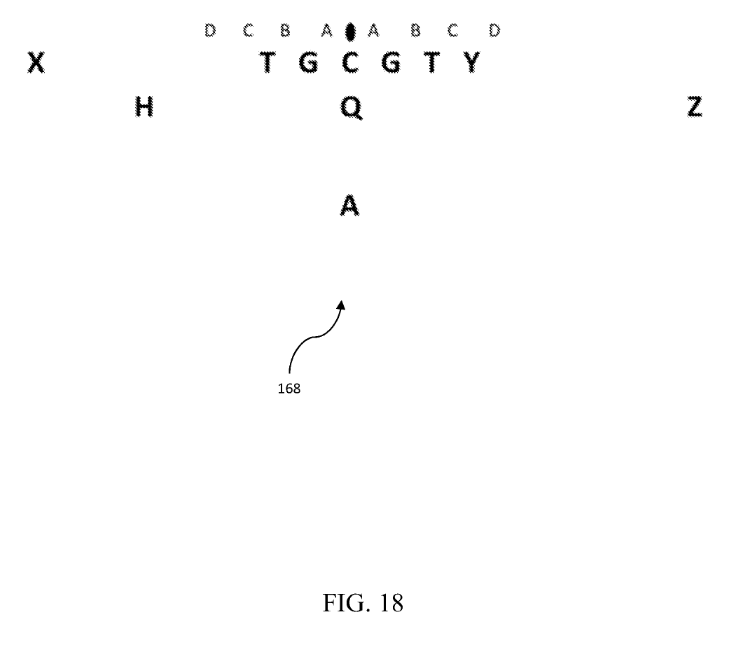

In FIG. 18, the offensive line gaps are lettered A, B, C, D. The “Buck Shot” call tells the linemen which gap to leave open as they shift. The linemen outside of the gap called will stay stationary. The gap exposed can create several play possibilities depending on what defense is presented and how the defense adjusts to the partial shift. The gap can create a running lane or a passing lane. It can also hide an eligible receiver until uncovered after another re-set. This is just another way that an offense can manipulate a defense to its advantage using the Buck Shift method.

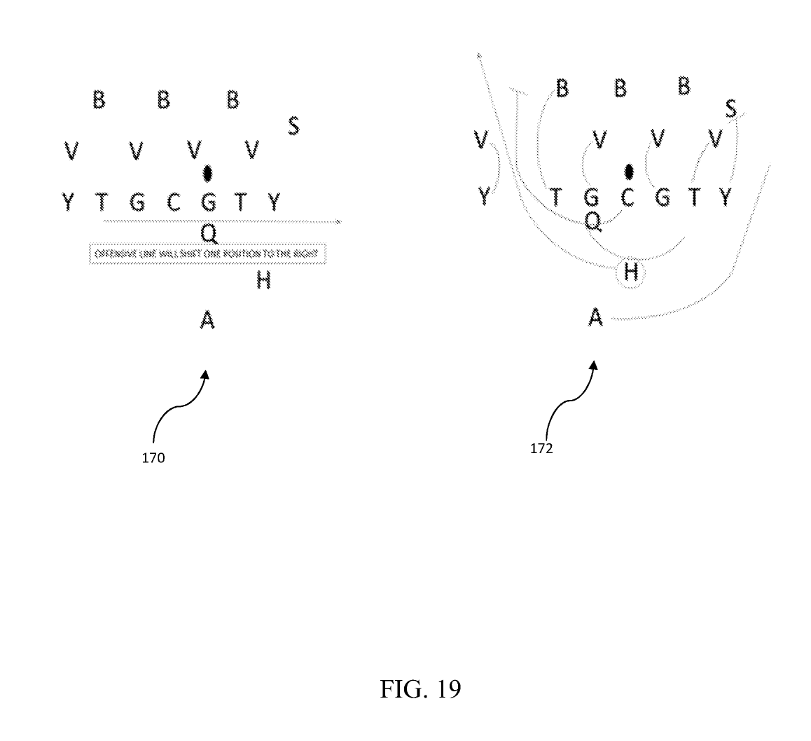

FIG. 19 illustrates the Buck Shift when the play called is “Unbalanced Monster Left, Buck Shot D232 &.” As the Buck Shift starts at D gap, it leaves a Y Flex look as shown above.

To explain the working elements a bit more clearly, the call “Unbalanced Monster Left, Buck Shot D232 &” tells the left Y to stay stationary and the rest of the offensive line—inside of the D gap—to Buck Shift right one gap from the first position (170) to the second position (172). Because the letter in the play call is before (that is, left) of the numbers, the Buck Shot gap is on the left side.

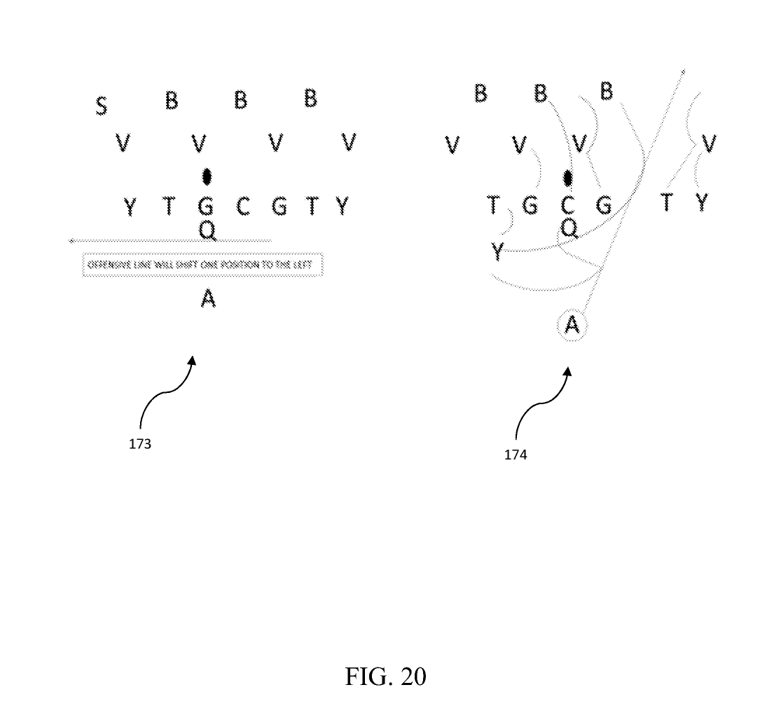

Another Buck Shot example is shown in FIG. 20, namely, “Unbalanced Monster Right, Buck Shot 112C, &.” This call tells the right T and Y to stay stationary and the rest of the Offensive Line inside of the C gap to Buck Shift left one gap from the first position (173) to the second position (174). Again, because the play call now has the numbers first and the letter (C) after (on the right of) the numbers, the Buck Shot will be on the right side.

After the Buck Shift, the D gap widens as the offense lets the defense adjust (“&”). This gives the runner a wide running lane as the defense splits to match the split in the offensive line.

Pass Blocking Applications

The discussion to this point has focused primarily on run plays. However, because of the severe run advantages the Buck Shift method offers, the play action passing game also becomes incredibly effective. As defenders attack their run responsibilities after a Buck Shift, and then the Quarterback pulls the ball from the running back and drops back or rolls out for a pass attempt, the defense is put into a divisive position.

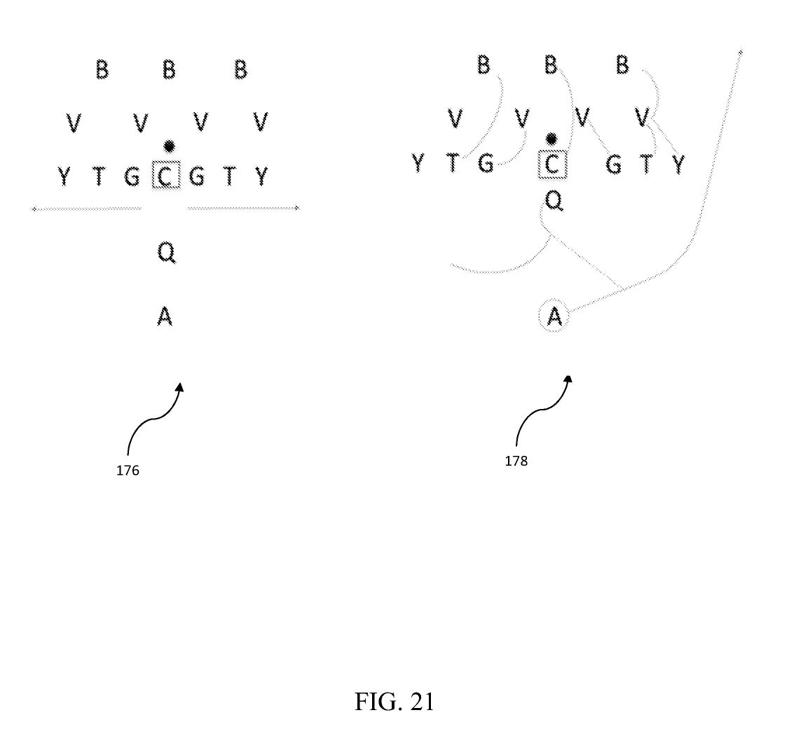

As illustrated in FIGS. 21 & 22, Buck Out is a method that might advantageously be executed to attack the perimeter first, then come back later with “&” and penetrate the middle. It can be effective against multiple fronts. In an even look, the offense just opened a huge gap for both inside defensive linemen to penetrate after moving from a first position (176 or 180) to a second position (178 or 182). In an odd front, the offense forces the Defensive Tackles to stem out, and even if they don't, they are still covered by the Offensive Guards. After attacking the edge with tempo, counter play possibilities could be a bootleg, dive, inside counter, double screen, draw and read option among others that the offense may be comfortable with.

Beyond just using the Buck Shift for play action pass plays, the Buck Shift can be called at any time prior to the play or as a pass blocking adjustment for the passing game at the line of scrimmage if the Quarterback recognizes a pressure or blitz. Because of the visual slide appearance, the offensive line can be shifted, in the direction as a blitz pick-up like a pre-snap slide protection.

Strategic Video Animation

Animation programs according to this disclosure illustrate the Buck Shift using animation of all or part of the offensive team from any view that will occur to those skilled in the art. In some implementations, an overhead or top perspective view shows the position of the players, while in some embodiments, the animation illustrates the first-person view of an individual offensive player or “follow camera” view showing the player and a view of the field during one or more Buck Shifts as described herein. Some embodiments allow coaches to show how the play is then executed after the snap as well. In some embodiments, lifelike characters are animated to perform the indicated movements, while in others, avatars (such as symbols, partial photographs, letters, numbers, shapes, and the like) perform the movements. In some embodiments, these movements are simply animated as movements, while in others, lines and/or other annotations show players' paths of movement. Programming instructions that implement these animations and/or illustrations are stored in a memory in communication with a processor, then executed by the processor to display the animation.

In various implementations, this unique strategic video animation tool will be used by players and coaches at all levels of the game from junior high to high school, to college and professional leagues, in order to reveal these new pre-snap schemes and broaden their teams' strategic advantage. In others, this video animation tool assists the automatic or manual review of live or captured video, tagging, instruction, correction, strategic development, tactical brainstorming, and other processes that will occur to those skilled in the art.

Statistics and Tendencies

In most conferences, it is mandatory for teams to trade game film in advance of a contest. This gives each coaching staff a chance to prepare for the tendencies of the other team. In some implementations of the present system, statistics are generated to correlate execution of a Buck Shift (or one or more types or specific variations thereof) with particular segments of video and/or one or more particular game contexts. In various embodiments, these contexts will include the period of play, down, yards to go, time remaining in the period, field position, and/or other variables—and/or ranges thereof—as will occur to those skilled in the art. In some embodiments, a database stores information about these correlations and/or specific instances of shifts, plays, and their contexts, then enables fixed or flexible analysis of that data (and/or those data points) to yield probabilistic information characterizing occurrence (or nonoccurrence) of Buck Shifts, plays run after particular Buck Shifts (or types thereof), defensive responses to Buck Shifts, play sequences including Buck Shifts, and other tendencies, analytics, metrics, and recommendations derived from the data as will occur to those skilled in the art in view of this disclosure. Programming instructions that implement this capture and/or analysis of data are stored in a memory in communication with a processor, then executed by the processor.

By implementing variations of the Buck Shift method, the offense compounds the possible scenarios for each play by thousands of different movements. Multiply that by the hundreds of situational possibilities and the dozens of formational possibilities, and the offense has watered down the tendency possibilities of its opponent by at least hundreds of thousands of different possibilities (or more) just by introducing the Buck Shift method.

Gaming Applications

Video football gaming has evolved into a realistic experience. The players look real; the sounds seem real. Even the offensive and defensive play choices are just like real-life play charts with up-to-date terminology. Some implementations of the present disclosure will comprise football video games, such as the famous “MADDEN NFL” and “NCAA Football” series by EA Sports, wherein the Buck Shift methods and movements disclosed herein and/or variations as will occur to those skilled in the art are integrated into the play selection process and selected by real or AI players, then executed in the game, such as by way of on-screen animation or display of results of that selection. In some of these embodiments, behavior of specific AI participants (at the coach, team, line, and/or individual player level) takes into account confusion, hesitation, and/or uncertainty resulting from Buck Shifts during the current and/or previous plays. Programming instructions that implement these games are stored in a memory in communication with a processor, then executed by the processor.

All publications, prior applications, and other documents cited herein are hereby incorporated by reference in their entirety as if each had been individually incorporated by reference and fully set forth. While the invention has been illustrated and described in detail in the drawings and foregoing description, the same is to be considered as illustrative and not restrictive in character, it being understood that only certain preferred embodiments have been shown and described and that all changes and modifications that come within the spirit of the invention are desired to be protected.

1. A training system for American football comprising a training device, wherein the training device is adapted to:
(a) display a set of symbols at a first position, each symbol of the set of symbols corresponding to an offensive player, wherein a first player associated with a first symbol in the set of symbols is aligned with a ball prior to a snap; and
(b) display the set of symbols at a second position, wherein the second position has a subset of the set of symbols shifted relative to the first position, wherein the subset of the set of symbols corresponds to at least two members of an offensive line, and wherein a second player associated with a second symbol in the set of symbols is aligned with the ball prior to the snap, the second player being one of the offensive players other than the first player.

2. The training system of claim 1, wherein the training device is further adapted to:
(c) provide an indication that, after a pause of at least one second after the display of the set of symbols at the second position, the ball is to be snapped.

3. The training system of claim 1, wherein the training device is further adapted to:
(c) after displaying the set of symbols at the second position, display the set of symbols at a third position prior to the snap, wherein the third position has a second subset of the set of symbols shifted relative to the second position, wherein the second subset of the set of symbols corresponds to at least two members of the offensive line, and wherein a third player associated with a third symbol in the set of symbols is aligned with the ball, the third player being one of the offensive players other than the second player.

4. The training system of claim 3, wherein the training device is further adapted to, before step (c):
(b1) display a set of defensive symbols at a first defensive position, each symbol of the set of defensive symbols corresponding to a defensive player; and
(b2) display the set of defensive symbols at a second defensive position.

5. The training system of claim 1, wherein the training device comprises a computing device, and wherein the computing device is operable to display a simulated training environment.

6. The training system of claim 1, wherein the first player is a guard, and the second player is a center.

7. The training system of claim 1, wherein the first player is a center, and the second player is a guard.

8.-17. (canceled)

18. An American football training method comprising the steps:
(a) displaying a set of player symbols at a first position, each symbol of the set of player symbols corresponding to one offensive player, wherein a first player symbol of the set of player symbols is aligned with a ball prior to a snap; and
(b) displaying the set of player symbols at a second position prior to the snap, wherein, in the second position:
i) a subset of the set of player symbols is shifted relative to the first position,
ii) the subset of the set of player symbols corresponds to at least two members of an offensive line, and
iii) a second player symbol of the set of player symbols is aligned with the ball.

19. The method of claim 18, further comprising the step of, after displaying the set of player symbols at the second position:
(c) displaying the set of player symbols at a third position prior to the snap, wherein, in the third position:
i) a second subset of the set of player symbols is shifted relative to the second position,
ii) the second subset of the set of player symbols corresponds to at least two members of the offensive line, and
iii) a player symbol is aligned with the ball, the player symbol selected from the group consisting of the first player symbol and a third player symbol of the set of player symbols.

20. The method of claim 19, further comprising the steps of, before displaying the set of player symbols at the third position:
(a′) displaying a set of defensive player symbols at a first defensive position, each symbol of the set of defensive player symbols corresponding to one defensive player; and
(b′) displaying the set of defensive symbols at a second defensive position.

21. The method of claim 18, wherein displaying the set of player symbols at the first position and displaying the set of player symbols at the second position are performed by a training device comprising a computing device, wherein the computing device is operable to display a simulated training environment.

22. The method of claim 18, wherein the first player is a guard, and the second player is a center.

23. The method of claim 18, wherein the first player is a center, and the second player is a guard.

24. The method of claim 18, wherein each of the set of player symbols is configured to be displayed as one or more of:
(a) an avatar associated with the offensive player corresponding to that player symbol;
(b) a text string associated with the offensive player corresponding to that player symbol; or
(c) a lifelike rendering associated with the offensive player corresponding to that player symbol.

25. A simulation training system for American football comprising a training device, wherein the training device is adapted to, during a simulation:
(a) provide a pre-shift segment, wherein the pre-shift segment displays a set of offensive players at a pre-shift position wherein a first one of the set of offensive players is aligned with a ball;
(b) after the pre-shift segment, provide a shift indicator;
(c) after the shift indication, provide a post-shift segment, wherein the post-shift segment displays the set of offensive players at a post-shift position wherein a second one of the set of offensive players is aligned with the ball;
(d) at least one second after providing the post-shift segment, provide a safe-shift indicator;
(e) after a final safe-shift indicator, provide a set indicator; and
after the set indicator, provide a play start indicator;
wherein the training device is further adapted to:
provide the pre-shift segment and the post-shift segment as a shift segment one or more times,
after each shift segment, change the pre-shift position and the post-shift position prior to a subsequent shift segment, and
during a final shift segment, provide the final safe-shift indicator instead of the safe-shift indicator.

26. The system of claim 25, wherein the training device is further adapted to provide the indicators using one or more of:
(a) an audio device operable to provide indicators audibly, or
(b) a video display operable to provide indications as one or more of:
i) a visual command; or
ii) a change in the visual appearance of a simulated football play.

27. The system of claim 25, wherein the training device is further adapted to provide a defensive position update after each shift segment, wherein the defensive position update displays a set of defensive players moving from a starting position to a reactive position.

28. The system of claim 27, wherein the training device is further adapted to provide the final safe-shift indicator after the set of defensive players has moved from the starting position but before the set of defensive players has reached the reactive position.

29. The system of claim 25, wherein the training device comprises a user input controller adapted to receive a set of inputs from a user, wherein the set of inputs are adapted to provide user interaction with the simulation.

30. The training system of claim 29, wherein the training device is further adapted to provide the shift indicator, the set indicator, and the play start indicator in response to the set of inputs, and wherein the pre-shift position and the post-shift position for each shift segment are determined as a factor of the set of inputs.
